(19) United States
(12) Patent Application Publication
(10) Pub. No.: US 2025/0214463 A1
(43) Pub. Date: Jul. 3, 2025

(54) METHOD AND APPARATUS FOR PREVENTING VEHICLE CHARGING OVERHEATING

(71) Applicants: Hyundai Motor Company, Seoul (KR); Kia Corporation, Seoul (KR); Yura Corporation Co., Ltd., Gyeonggi-do (KR)

(72) Inventors: Kwang Moo Lee, Suwon-si (KR); Jae Han Jeong, Seoul (KR); Myoung Jae Lee, Seongnam-si (KR); Sang Kyung Han, Incheon (KR)

(21) Appl. No.: 18/950,460

(22) Filed: Nov. 18, 2024

(30) Foreign Application Priority Data
Dec. 27, 2023 (KR) 10-2023-0192987

(51) Int. Cl. B60L 53/16; B60L 53/62

(52) U.S. Cl. CPC B60L 53/16; B60L 53/62

(57) ABSTRACT

An embodiment method of detecting overheating during charging of a vehicle includes monitoring a temperature of a plug connected to an electrical outlet configured to supply a charging voltage for charging a battery of the vehicle, determining an average amount of change in temperature of the plug per unit time based on the temperature of the plug, and cutting off charging in response to the average amount of change in temperature of the plug per unit time exceeding a preset threshold range.

### CROSS-REFERENCE TO RELATED APPLICATIONS

The present application claims the benefit of Korean Patent Application No. 10-2023-0192987, filed on Dec. 27, 2023, which application is hereby incorporated herein by reference.

### TECHNICAL FIELD

The present disclosure relates to a technology for preventing overheating during a process of charging a vehicle.

### BACKGROUND

An in-cable control box (ICCB) refers to a portable slow charger for charging a plug-in hybrid vehicle (PHEV) or an electric vehicle (EV). A user may directly carry the ICCB and charge an environmentally friendly vehicle by using a household 220V plug by fastening the ICCB to an electrical outlet and the vehicle. Because the user uses the ICCB by directly fastening the ICCB to the electrical power outlet, various safety function specifications are embedded in the ICCB.

In case that a plug is fastened to the electrical outlet in an abnormal state of the ICCB or an extension line is arbitrarily used because of a long distance from the electrical outlet, heat is generated by an increase in contact resistance, and there is a risk of a fire.

Therefore, the ICCB serves to detect an abnormality of an input voltage and detect a leakage current, an overcurrent, or the like. Further, a temperature sensor is embedded in a power plug, such that when overheating occurs because of a user's mistake and a charging environment, the ICCB serves to transmit an alarm to the user and cut off charging. Various temperature sensors are applied depending on manufacturers of the ICCB. However, a thermistor is generally applied to monitor a temperature.

However, because the ICCB products in the related art mostly adopt temperature sensors provided in the plugs, the shape of the plug and the structure having the temperature sensor make it difficult for many products to detect overheating that suddenly occurs.

Meanwhile, contact resistance of the ICCB is increased by the introduction of foreign substances or a loss of a pull-out force and a restoring force of a blade holder in an aged electrical outlet, and a large amount of heat is generated within a short period of time because of the increase in contact resistance. For this reason, it is difficult to immediately prevent a fire because of a structural problem even though the temperature sensor is applied to the ICCB plug. A relationship between the pull-out force and the restoring force of the blade holder of the electrical outlet varies depending on facility manufactures, and replacement and inspection cycles for the blade holder are regulated. However, there is a problem in that a risk of an electric fire increases in proportion to the actual number of years for which the blade holder is used, and the replacement cycle cannot be accurately determined because there are no regulations related to the indication of the year of installation of the electrical outlet.

Accordingly, in the present technical field, there is a need for an improved structure of the ICCB and an overheating detection logic capable of preventing the occurrence of a fire caused by overheating.

### SUMMARY

The present disclosure relates to a technology for preventing overheating during a process of charging a vehicle. Particular embodiments relate to a method and an apparatus for preventing overheating during a process of charging a battery of an environmentally friendly vehicle.

Accordingly, embodiments of the present disclosure keep in mind problems occurring in the related art, and embodiments of the present disclosure provide an improved structure of an ICCB and an overheating detection logic capable of preventing the occurrence of a fire caused by overheating.

Embodiments of the present disclosure also provide a technology capable of detecting in advance an electrical outlet that is likely to ignite.

Technical problems solvable by embodiments of the present disclosure are not limited to the above-mentioned technical problems, and other technical problems, which are not mentioned above, may be clearly understood from the following descriptions by those skilled in the art to which the present disclosure pertains.

According to one embodiment, there is provided a method of detecting vehicle charging overheating, the method including monitoring a temperature of a plug connected to an electrical outlet configured to supply a charging voltage for charging a battery of an environmentally friendly vehicle, determining the average amount of change in temperature of the plug per unit time based on the temperature of the plug, and cutting off the charging in response to the average amount of change in temperature per unit time exceeding a preset threshold range.

In this case, the method of detecting vehicle charging overheating may further include initializing a time counter at a time point at which the monitoring of the temperature of the plug is initiated and counting the time counter.

In this case, the determining of the average amount of change in temperature of the plug per unit time may include determining whether a value of the time counter exceeds a preset threshold time and determining the average amount of change in temperature of the plug per unit time based on the temperature of the plug in response to the value of the time counter exceeding the threshold time.

In this case, the monitoring of the temperature of the plug may include performing analog-digital conversion on the temperature of the plug at a preset predetermined cycle, storing the temperature of the plug each time the analog-digital conversion is performed, and storing the number of times the analog-digital conversion has been performed.

In this case, the determining of the average amount of change in temperature of the plug per unit time may include cumulatively adding up the amounts of changes in temperatures of the plug to the threshold time at the preset predetermined cycle and determining the average amount of change in temperature of the plug per unit time by dividing the amount of change in temperature of the plug, which is cumulatively added up, by the number of times the analog-digital conversion has been performed.

According to another embodiment, there is provided an apparatus for detecting vehicle charging overheating, the apparatus including a processor configured to monitor a temperature of a plug connected to an electrical outlet configured to supply a charging voltage for charging a battery of an environmentally friendly vehicle, determine the average amount of change in temperature of the plug per unit time based on the temperature of the plug, and cut off the charging in response to the average amount of change in temperature per unit time exceeding a preset threshold range and a memory configured to store the temperature of the plug.

In this case, the processor may initialize a time counter at a time point at which the monitoring of the temperature of the plug is initiated, and the processor may count the time counter.

In this case, the processor may determine whether a value of the time counter exceeds a preset threshold time, and the processor may determine the average amount of change in temperature of the plug per unit time based on the temperature of the plug in response to the value of the time counter exceeding the threshold time.

In this case, the processor may perform analog-digital conversion on the temperature of the plug at a preset predetermined cycle, the processor may store the temperature of the plug in the memory each time the analog-digital conversion is performed, and the processor may store, in the memory, the number of times the analog-digital conversion has been performed.

In this case, the processor may cumulatively add up the amounts of changes in temperatures of the plug to the threshold time at the preset predetermined cycle, and the processor may determine the average amount of change in temperature of the plug per unit time by dividing the amount of change in temperature of the plug, which is cumulatively added up, by the number of times the analog-digital conversion has been performed.

Various embodiments of the present disclosure described above provide the improved structure of the ICCB and the overheating detection logic capable of preventing the occurrence of a fire caused by overheating.

In addition, it is possible to detect in advance an electrical outlet that is likely to ignite.

The effects obtainable by embodiments of the present disclosure are not limited to the aforementioned effects, and other effects, which are not mentioned above, will be clearly understood by those skilled in the art from the following description.

### BRIEF DESCRIPTION OF THE DRAWINGS

FIG. 1 illustrates an environmentally friendly vehicle charging system according to an embodiment of the present disclosure.

FIGS. 2A to 2C illustrate examples of powers, currents, and voltages measured at a contact portion between an electrical outlet and a plug over time when an oxide is produced in the charging system in FIG. 1.

FIG. 3 illustrates an example of an isolation integrated circuit (IC) that may be used for a charging device in FIG. 1 to prevent a fire.

FIG. 4 illustrates a method of detecting overheating according to an embodiment of the present disclosure.

FIG. 5 illustrates a method of detecting overheating according to another embodiment of the present disclosure.

FIG. 6 illustrates an example in which a temperature of a plug is rapidly increased by a fastening defect of an electrical outlet according to an embodiment of the present disclosure.

FIG. 7 illustrates a computer system according to an embodiment of the present disclosure.

### DETAILED DESCRIPTION OF ILLUSTRATIVE EMBODIMENTS

Hereinafter, embodiments disclosed in the present specification will be described in detail with reference to the accompanying drawings. The same or similar constituent elements are assigned with the same reference numerals regardless of the figure number, and the repetitive description thereof will be omitted. The suffixes “module,” “unit,” “part,” and “portion” used to describe constituent elements in the following description are used together or interchangeably in order to facilitate the description, but the suffixes themselves do not have distinguishable meanings or functions. In addition, in the description of the exemplary embodiments disclosed in the present specification, the specific descriptions of publicly known related technologies will be omitted when it is determined that the specific descriptions may obscure the subject matter of the exemplary embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

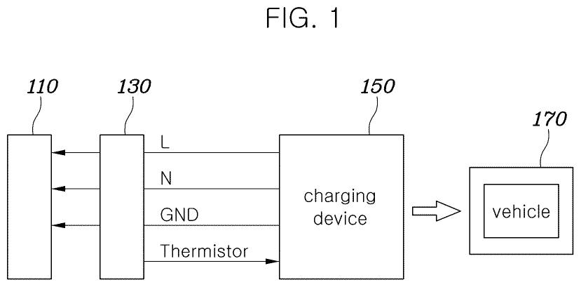

FIG. 1 illustrates an environmentally friendly vehicle charging system according to an embodiment of the present disclosure.

With reference to FIG. 1, an environmentally friendly vehicle charging system according to the present embodiment includes an electrical outlet 110, a plug 130, a charging device 150, and a vehicle 170.

The electrical outlet 110 supplies AC power to an electronic device and the like physically connected to the electrical outlet 110.

The plug 130 is connected to an end of a cord connected to the charging device 150 and physically connected to the electrical outlet 110, such that the plug 130 receives power required for the charging device 150 from the electrical outlet 110.

The charging device 150 charges the vehicle 170 by receiving power from the electrical outlet 110 through the plug 130.

In this case, the charging device 150 may be an in-cable control box (ICCB).

A battery provided in the vehicle 170 is charged by the charging device 150.

In general, because moisture is in an electrolyte aqueous solution state to some extent, the moisture has properties of an electrical conductor. Therefore, resistance components are reduced when a humidity is high because of moisture. In contrast, because foreign substances such as soil have properties of a nonconductor, the resistance components are increased when foreign substances are present in the electrical outlet 110 or on a terminal of the plug 130. Therefore, in case that a tensile force of a blade holder is decreased because of the aging of a terminal of the electrical outlet 110 or moisture or foreign substances are introduced because of poor maintenance, contact resistance between the electrical outlet 110 and the plug 130 changes.

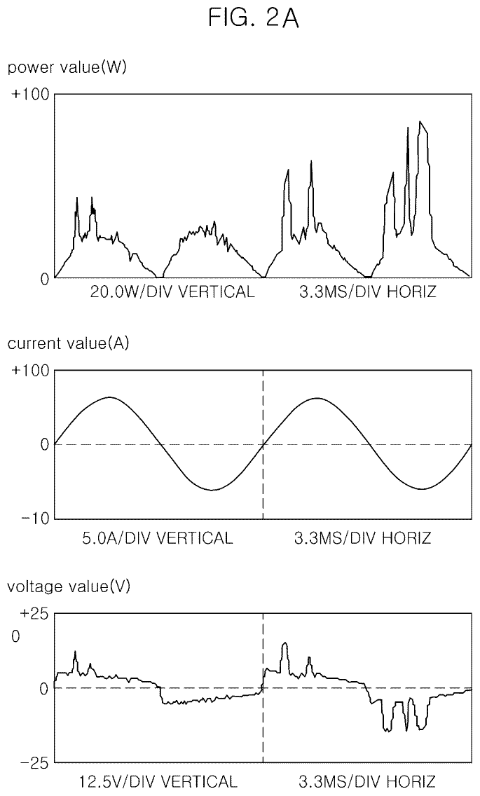

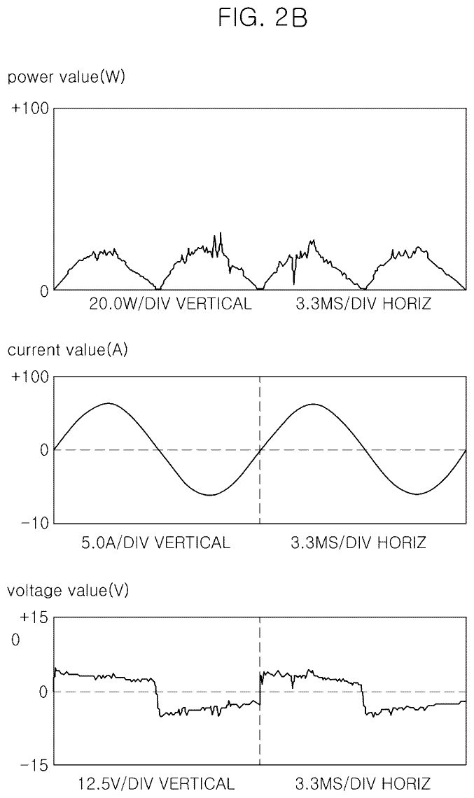

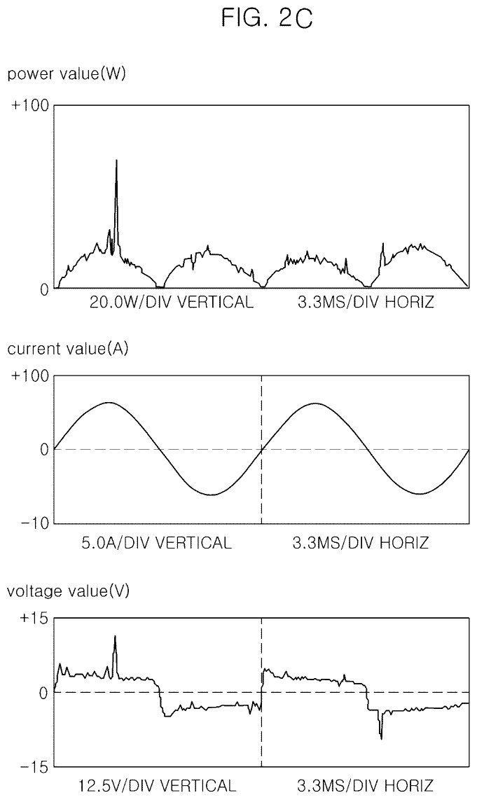

For example, FIGS. 2A to 2C illustrate examples of powers, currents, and voltages measured at a contact portion between the electrical outlet and the plug over time when an oxide is produced because of the aging of the blade holder of the electrical outlet 110.

FIG. 2A illustrates an example of a power value, a current value, and a voltage value measured at the contact portion when an oxide begins to be produced, and FIG. 2B illustrates an example of a power value, a current value, and a voltage value measured at the contact portion at a time point at which 60 minutes have elapsed after an oxide begins to be produced. In addition, FIG. 2C illustrates an example of a power value, a current value, and a voltage value measured at the contact portion at a time point at which 120 minutes have elapsed after an oxide begins to be produced.

With reference to FIGS. 2A to 2C, it can be seen that when the contact resistance changes as an oxide is produced at the contact portion, a voltage value of the contact portion changes based on V=IR because a load current is in a constant state. This has the same effect that occurs when an input voltage value inputted to the charging device 150 changes.

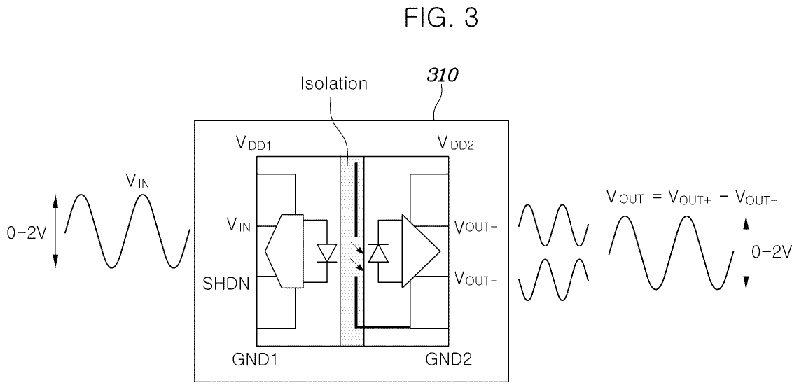

FIG. 3 illustrates an example of an isolation IC that may be used for a charging device in FIG. 1 to prevent a fire. The isolation IC detects resistance of the terminal by converting the amount of change in alternating current (AC) voltage into a direct current (DC) voltage.

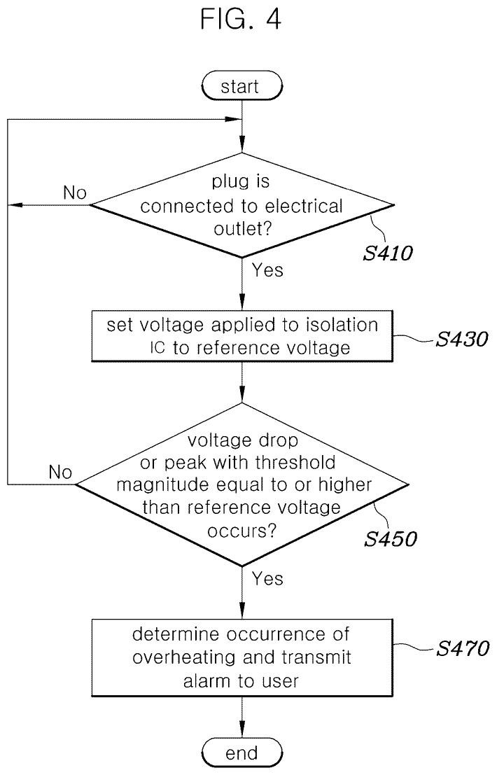

The charging device including the isolation IC detects overheating by using a method according to the following embodiment in FIG. 4.

FIG. 4 illustrates a method of preventing overheating according to an embodiment of the present disclosure.

The method of preventing overheating according to the present embodiment may be performed by the charging device 150 in FIG. 1. In this case, the charging device 150 may be a charging device in which the isolation IC is provided.

With reference to FIG. 4, the charging device 150 determines whether the plug 130 is connected to the electrical outlet 110 (S410), and the charging device 150 sets a voltage, which is applied to the isolation IC, to a reference voltage when the plug 130 is connected to the electrical outlet 110 (S430).

A standard voltage supplied by an electric power distribution company, such as the Korea Electric Power Corporation (KEPCO), to each household is 220 V (AC), a reference permissible error is ±13 V (in a voltage range of 207 to 233 V), and a voltage environment varies depending on the households. Therefore, a voltage, which is initially applied to the isolation IC, may be set as a reference voltage, and the terminal resistance and overheating may be determined by detecting a subsequent change in voltage.

For example, when the voltage, which is initially applied to the isolation IC, is 210 V, 210 V may be set as the reference voltage.

In addition, the charging device 150 may determine whether a voltage drop or peak with a threshold magnitude equal to or higher than the reference voltage is generated (S450).

In this case, in case that the contact resistance increases because of the occurrence of a contact defect between the electrical outlet 110 and the plug 130, a voltage drop with a threshold magnitude equal to or higher than the reference voltage may occur, or a voltage peak with the threshold magnitude or higher may occur.

In case that the determination result in step S450 indicates that a voltage drop with the threshold magnitude equal to or higher than the reference voltage occurs or a voltage peak with the threshold magnitude or higher occurs, it is determined that overheating occurs, and an alarm is transmitted to a user (S470).

Meanwhile, in the present embodiment, the charging device 150 may use an isolation photocoupler IC because the charging device 150 needs to detect the change in alternating current (AC) voltage as a direct current (DC) and identify the direct current (DC) by means of a micro-controller unit (MCU).

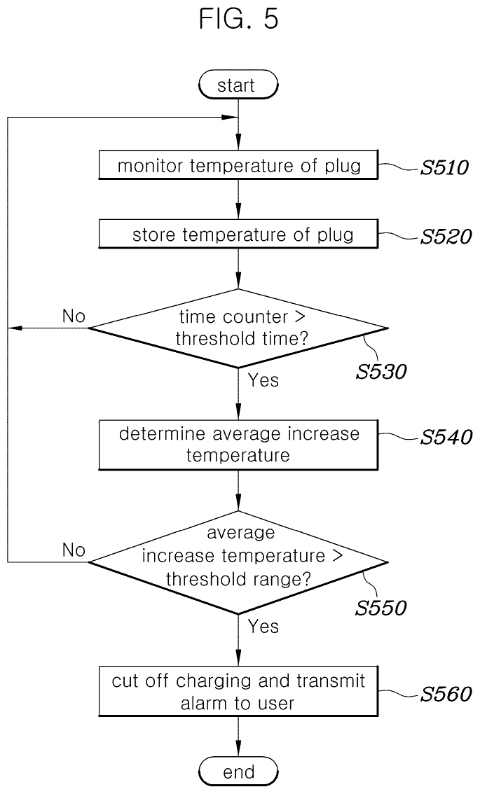

FIG. 5 illustrates a method of detecting overheating according to another embodiment of the present disclosure.

The method of detecting overheating according to the present embodiment may be performed by the charging device 150 in FIG. 1.

In addition, according to the present embodiment, overheating may be detected based on sensing information of a temperature sensor. The micro-controller unit (MCU) in the charging device 150 may determine overheating by performing analog-digital conversion (ADC) on a resistance value of a negative temperature coefficient (NTC) temperature sensor in the plug 130. Because the current of 10 A or more flows while the charging process is performed in a normal state, only low-temperature heat with 60° C. or less is generated. However, intense heat is rapidly generated in a situation in which a defect of the electrical outlet occurs or foreign substances are introduced. In case that a temperature measured by the temperature sensor rapidly changes, a software logic may be designed to cut off the charging and prevent overheating. For example, when a temperature value detected by the temperature sensor rapidly changes before the temperature reaches a preset cut-off temperature in case that a predetermined charging cut-off value according to the temperature is 100° C., information may be transferred to the user in advance to prevent overheating of the charging device 150. It is possible to prevent a fire by detecting not only a target temperature but also the amount of change in temperature by using the above-mentioned configuration.

With reference to FIG. 5, the charging device 150 monitors a temperature of the plug 130 (S510).

In this case, the monitoring of the temperature of the plug 130 may be performed at each analog-digital conversion (ADC) cycle that converts the temperature measured as analog data into digital data.

For example, in case that the ADC cycle is 1 ms, the charging device 150 may monitor the temperature of the plug 130 at each cycle of 1 ms.

In addition, the temperature of the plug 130 measured by the temperature sensor may be analog data, and the charging device 150 may convert the temperature measured as the analog data into digital data at each ADC cycle and store the digital data.

In this case, the charging device 150 may initialize a value of a time counter to 0 at a time point at which the monitoring of the temperature of the plug is initiated, and the elapsed time may be counted by increasing the time counter value over time from the time point at which the counter value is initiated.

In addition, the charging device 150 stores the temperature of the plug 130 in an internal memory (S520).

In this case, the temperature of the plug 130 may be stored at predetermined time intervals and stored at each monitoring cycle.

For example, in case that the temperature monitoring cycle for the plug 130 is 1 ms, the temperature of the plug 130 may be stored at each monitoring cycle of 1 ms.

In this case, the temperatures of the plug 130 may be sequentially stored in an array (Aₙ).

In addition, the charging device 150 may complexly add up all the calculated amounts of changes in temperatures of the plug 130 and cumulatively store the total sum of the amount of change in temperatures in the array.

In this case, the amount of change in temperature may be determined based on Equation 1 below.

$${T}_{n} = {A}_{( n + 1 )} - {A}_{n} \qquad \underline{Equation l}$$

In Equation 1, T₈ represents the amount of change in temperature of the plug 130 between a time point, at which any ADC is performed, and a next time point, A₍ₙ₊₁₎ represents a temperature of the plug 130 at an (n+1) time point, and Aₙ represents a temperature of the plug 130 at an n time point.

For example, the ADC may be performed 1,000 times for 1 second, and n may be 1,000.

In addition, a total sum of the amount of change in temperature may be determined based on Equation 2 below.

$${T}_{sum} = {T}_{1} + {T}_{2} + … + {T}_{n} \qquad \underline{Equation 2}$$

In Equation 2, Tₛᵤₘ represents a total sum of the amount of change in temperature to a time point at which the monitoring of the temperature of the plug is completed.

In addition, the charging device 150 determines whether a value of the time counter exceeds a preset threshold time (S530).

In this case, the preset threshold time may be set to any value, e.g., 1 second.

In this case, the time counter operates as a timer for counting the elapsed time. For example, the time counter may be a timer configured to increase a value of 1 every 1 ms. For example, it may be determined that the condition of step S530 is satisfied at the moment when a value of the time counter exceeds 1,000 and has a value of 1,001.

In case that the determination result in step S530 indicates that the value of the time counter exceeds a preset threshold time, the charging device 150 determines an average increase temperature of the plug per unit time based on the array of the temperature values of the plug 130 stored in the memory (S540).

For example, in case that the value of the time counter exceeds 1 second, the charging device 150 calculates the average increase temperature per unit time based on the array of the temperature values of the plug 130 stored in the memory.

In this case, the charging device 150 obtains an average value (T_{avg}) of the amounts of changes in temperatures by dividing the total sum of the amounts of changes in temperature, which are complexly added up based on Equation 2, by the number of times the ADC has been performed on the temperature of the plug 130 for the threshold time.

For example, in case that the threshold time is 1 second, the average of the amounts of changes in temperatures may be determined based on Equation 3 below.

$${T}_{avg} = {T}_{sum} / n \qquad \underline{Equation 3}$$

In Equation 3, T_{avg} represents an average of the amounts of changes in temperatures up to a threshold time point, Tₛᵤₘ represents a total sum of the amounts of changes in temperatures up to the threshold time point, and n represents the number of times the ADC has been performed up to the threshold time. For example, the threshold time may be 1 second.

In addition, the charging device 150 determines whether the average increase temperature per time exceeds a preset threshold range (S550). In case that the average increase temperature per time exceeds the preset threshold range, the charging device 150 cuts off the charging and transmits an alarm to the user (S560).

In this case, the charging device 150 may cut off the charging by outputting a control pilot (CP) duty by 100%.

Meanwhile, in case that the determination result in step S530 indicates that the value of the time counter does not exceed the preset threshold time or in case that the determination result in step S550 indicates that the average increase temperature per time does not exceed the preset threshold range, the temperature of the plug 130 is continuously monitored (S510).

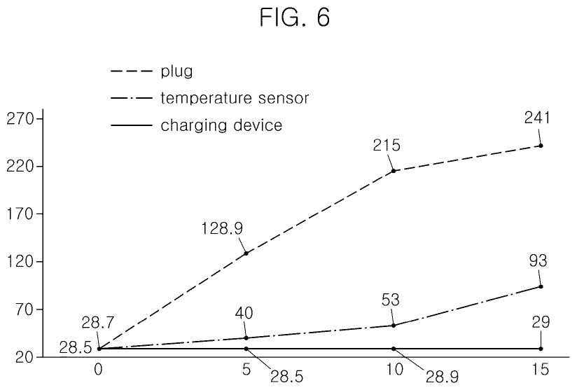

FIG. 6 illustrates an example in which a temperature of a plug is rapidly increased by a fastening defect of an electrical outlet according to an embodiment of the present disclosure.

With reference to FIG. 6, when the electrical outlet is defectively fastened and the temperature of the plug rapidly increases to 241° C. within a short period of time, the temperature sensor cannot immediately detect the rapid increase in temperature but may sense the temperature as 93° C. In addition, the ICCB in the related art may not detect the rapid increase in temperature at all.

However, the method of detecting overheating of embodiments of the present disclosure may detect overheating based on the amount of change in temperature of the temperature sensor that rapidly increases within a short period of time, such that it is possible to detect overheating of the contact terminal even before the sensing temperature reaches the threshold range.

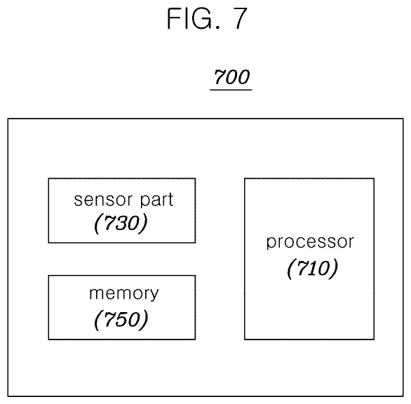

FIG. 7 is a block diagram illustrating a computer system according to an embodiment of the present disclosure.

With reference to FIG. 7, the present embodiment of the present disclosure may be implemented by the computer system such as a computer-readable recording medium. As illustrated in FIG. 7, a computer system 700 includes a processor 710, a sensor part 730, and a memory 750.

The processor 710 implements a method of diagnosing a voltage abnormality of a battery cell of an environmentally friendly vehicle proposed in the present specification. Specifically, the processor 710 implements all operations of the charging device 150 in an environmentally friendly vehicle charging system 100 described in the embodiments disclosed in the present specification and performs all operations of the method of detecting overheating in FIG. 5.

For example, the processor 710 monitors the temperature of the plug 130.

In this case, the temperature of the plug 130 may be measured at each analog-digital conversion (ADC) cycle that converts the temperature measured as analog data into digital data.

For example, in case that the ADC cycle is 1 ms, the charging device 150 may measure the temperature of the plug 130 at each cycle of 1 ms.

In addition, the processor 710 stores the temperature of the plug 130 in the memory 750.

In this case, the temperature of the plug 130 may be stored at predetermined time intervals and stored at each monitoring cycle.

For example, in case that the temperature monitoring cycle for the plug 130 is 1 ms, the temperature of the plug 130 may be stored at each monitoring cycle of 1 ms.

In this case, the temperatures of the plug 130 may be sequentially stored in an array (Aₙ).

In addition, the processor 710 may complexly add up all the calculated amounts of changes in temperatures of the plug 130 and cumulatively store the total sum of the amount of change in temperatures in the array.

In addition, the processor 710 determines whether a value of the time counter exceeds a preset threshold time.

In this case, the preset threshold time may be set to any value, e.g., 1 second.

In case that the value of the time counter exceeds the preset threshold time, the processor 710 determines the average increase temperature per time, i.e., the average amount of change in temperature per time based on the array of the temperature values of the plug 130 stored in the memory 750.

For example, in case that the value of the time counter exceeds 1 second, the processor 710 determines the average amount of change in temperature per time based on the array of the temperature values of the plug 130 stored in the memory 750.

In addition, the processor 710 determines whether the average increase temperature per time exceeds a preset threshold range. In case that the average increase temperature per time exceeds the preset threshold range, the processor 710 cuts off the charging and transmits an alarm to the user.

In this case, the charging device 150 may cut off the charging by outputting a control pilot (CP) duty by 100%.

The sensor part 730 monitors the temperature of the plug.

In this case, the sensor part 730 may include the temperature sensor.

The memory 750 may be various types of volatile or non-volatile storage media. In this case, the memory 750 stores at least one of the temperature of the plug, the time counter, the average increase temperature, the threshold range, the threshold time, and a combination thereof.

The embodiments of the present disclosure described above provide the improved structure of the ICCB and the overheating detection logic capable of preventing the occurrence of a fire caused by overheating.

In addition, it is possible to detect in advance an electrical outlet that is likely to ignite.

Meanwhile, embodiments of the present disclosure described above may be implemented as a computer-readable code on a medium on which a program is recorded. The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices. Therefore, it should be appreciated that the detailed description is interpreted as being illustrative in every respect, not restrictive. The scope of the present disclosure should be determined based on the reasonable interpretation of the appended claims, and all of the modifications within the equivalent scope of the present disclosure belong to the scope of the present disclosure.

What is claimed is:

1. A method of detecting overheating during charging of a vehicle, the method comprising:
monitoring a temperature of a plug connected to an electrical outlet configured to supply a charging voltage for charging a battery of the vehicle;
determining an average amount of change in temperature of the plug per unit time based on the temperature of the plug; and
cutting off charging in response to the average amount of change in temperature of the plug per unit time exceeding a preset threshold range.

2. The method of claim 1, further comprising:
initializing a time counter at a time point at which monitoring the temperature of the plug is initiated; and
counting the time counter.

3. The method of claim 2, wherein determining the average amount of change in temperature of the plug per unit time comprises:
determining whether a value of the time counter exceeds a preset threshold time; and
determining the average amount of change in temperature of the plug per unit time based on the temperature of the plug in response to the value of the time counter exceeding the preset threshold time.

4. The method of claim 3, wherein monitoring the temperature of the plug comprises:
performing analog-digital conversion on the temperature of the plug at a preset predetermined cycle;
storing the temperature of the plug each time the analog-digital conversion is performed; and
storing a number of times the analog-digital conversion has been performed.

5. The method of claim 4, wherein determining the average amount of change in temperature of the plug per unit time comprises:
cumulatively adding up an amount of change in the temperature of the plug to the preset threshold time at the preset predetermined cycle; and
determining the average amount of change in temperature of the plug per unit time by dividing the amount of change in the temperature of the plug, which is cumulatively added up, by the number of times the analog-digital conversion has been performed.

6. An apparatus for detecting vehicle charging overheating during charging of a vehicle, the apparatus comprising:
one or more processors;
a non-transitory storage device storing a program to be executed by the one or more processors, the program including instructions to:
monitor a temperature of a plug connected to an electrical outlet configured to supply a charging voltage for charging a battery of the vehicle;
determine an average amount of change in temperature of the plug per unit time based on the temperature of the plug; and
cut off charging in response to the average amount of change in temperature per unit time exceeding a preset threshold range; and
a memory configured to store the temperature of the plug.

7. The apparatus of claim 6, wherein the program further includes instructions to:
initialize a time counter at a time point at which monitoring of the temperature of the plug is initiated; and
count the time counter.

8. The apparatus of claim 7, wherein the program further includes instructions to:
determine whether a value of the time counter exceeds a preset threshold time; and
determine the average amount of change in temperature of the plug per unit time based on the temperature of the plug in response to a determination that the value of the time counter exceeds the preset threshold time.

9. The apparatus of claim 8, wherein the program further includes instructions to:
perform analog-digital conversion on the temperature of the plug at a preset predetermined cycle;
store the temperature of the plug in the memory each time the analog-digital conversion is performed; and
store, in the memory, a number of times the analog-digital conversion has been performed.

10. The apparatus of claim 9, wherein the program further includes instructions to:
cumulatively add up an amount of change in the temperature of the plug to the preset threshold time at the preset predetermined cycle; and
determine the average amount of change in temperature of the plug per unit time by dividing the amount of change in the temperature of the plug, which is cumulatively added up, by the number of times the analog-digital conversion has been performed.

11. The apparatus of claim 6, wherein the one or more processors are disposed in a charging device coupled between the plug and the battery disposed in the vehicle.

12. A vehicle comprising:
a battery;
an electrical outlet;
a charging device; and
a plug connecting the electrical outlet to the charging device;
wherein the charging device is configured to:
monitor a temperature of the plug in a state in which the plug is connected to the electrical outlet;
determine an average amount of change in temperature of the plug per unit time based on the temperature of the plug; and
cut off charging in response to the average amount of change in temperature of the plug per unit time exceeding a preset threshold range.

13. The vehicle of claim 12, wherein the charging device is further configured to:
initialize a time counter at a time point at which monitoring the temperature of the plug is initiated; and
count the time counter.

14. The vehicle of claim 13, wherein, to determine the average amount of change in temperature of the plug per unit time, the charging device is configured to:
determine whether a value of the time counter exceeds a preset threshold time; and
determine the average amount of change in temperature of the plug per unit time based on the temperature of the plug in response to a determination that the value of the time counter exceeds the preset threshold time.

15. The vehicle of claim 14, wherein, to monitor the temperature of the plug, the charging device is configured to:
perform analog-digital conversion on the temperature of the plug at a preset predetermined cycle;
store the temperature of the plug each time the analog-digital conversion is performed; and
store a number of times the analog-digital conversion has been performed.

16. The vehicle of claim 15, wherein, to determine the average amount of change in temperature of the plug per unit time, the charging device is configured to:
cumulatively add up an amount of change in the temperature of the plug to the preset threshold time at the preset predetermined cycle; and
determine the average amount of change in temperature of the plug per unit time by dividing the amount of change in the temperature of the plug, which is cumulatively added up, by the number of times the analog-digital conversion has been performed.

17. The vehicle of claim 12, wherein the plug further comprises a temperature sensor, and wherein, to monitor the temperature of the plug, the charging device is configured to receive the temperature of the plug measured by the temperature sensor.

18. The vehicle of claim 12, wherein the charging device comprises an in-cable control box.

19. The vehicle of claim 12, wherein the vehicle is an environmentally friendly vehicle.
